(19) United States
(12) Patent Application Publication
(10) Pub. No.: US 2023/0384197 A1
(43) Pub. Date: Nov. 30, 2023

(54) DETERMINING THE CRITICAL MICELLE CONCENTRATION UTILIZING SEDIMENTATION VELOCITY PROFILES

(71) Applicant: SAUDI ARABIAN OIL COMPANY, Dhahran (SA)

(72) Inventors: Ahmed Wasel Alsmaeil, Dhahran (SA); Mohammad Faisal Alhassani, Dhahran (SA)

(73) Assignee: SAUDI ARABIAN OIL COMPANY, Dhahran (SA)

(21) Appl. No.: 17/827,220

(22) Filed: May 27, 2022

(51) Int. Cl. G01N 13/02; G01N 15/04

(52) U.S. Cl. CPC G01N 13/02; G01N 15/042; G01N 2013/0275

(57) ABSTRACT

A method for measuring the critical micelle concentration of a surfactant solution is provided. The method includes preparing surfactant solutions with different concentration of the surfactant, measuring transmittance profiles of the surfactant solutions in a dispersion analyser under centrifugal force, translating changes in the transmittance profiles of the surfactant solutions to a sedimentation velocity, and using a relationship between the sedimentation velocity and the surfactant concentration to determine the critical micelle concentration of the surfactant.

### BACKGROUND

Surfactants are molecules consisting of a hydrophilic head and hydrophobic tail. The hydrophobic part is composed of a hydrocarbon chain whereas the hydrophilic part consists of an ionic species. Depending on the nature of the ionic species, surfactants are classified as anionic, cationic, nonionic, or amphoteric.

Surfactants are used in a variety of applications including industrial, medical, and household applications. In oil and gas, examples of such applications include, but are not limited to, enhanced oil recovery, well stimulation, or well drilling. Other applications include food processing, surface cleaning, pharmaceutical, and cosmetics applications.

Critical micelle concentration (CMC) is one of the most important physicochemical properties of surfactant solutions. Surfactant CMC values are useful to a wide range of important applications, including industrial, medical, and household applications. The critical micelle concentration is defined as the surfactant concentration at and above which the surfactant molecules start to aggregate and form micelles. At the CMC, properties such as surface tension, interfacial tension, osmotic pressure, absorption and fluorescence as a function of surfactant concentration change abruptly because of micellular formation. Therefore, measuring the CMC is essential for applications such as foaming, wettability alteration and interfacial tension (IFT) reduction.

The critical micelle concentration of surfactant solutions can be determined by several different methods. Examples of methods include UV-vis spectrophotometry, fluorimetry, infrared spectroscopy, light scattering, nuclear magnetic resonance, chromatography, sound velocity, calorimetry, and electrochemical techniques. One of the most frequently used methods for measuring the CMC is based on the surface tension at different bulk surfactant concentrations. These methods are time consuming and require large sample volume.

### SUMMARY

This summary is provided to introduce a selection of concepts that are further described in the detailed description. This summary is not intended to identify key or essential features of the claimed subject matter, nor is it intended to be used as an aid in limiting the scope of the claimed subject matter.

In one aspect, embodiments disclosed herein relate to a method for measuring the critical micelle concentration (CMC) of a surfactant solution using sedimentation velocity profiles. The method includes preparing surfactant solutions with a different concentration of the surfactant, measuring transmittance profiles of the surfactant solutions in a dispersion analyser under centrifugal force, translating changes in the transmittance profiles of the surfactant solutions to a sedimentation velocity, and using a relationship between the sedimentation velocity and the surfactant concentration to determine the critical micelle concentration of the surfactant.

Other aspects of the disclosure will be apparent from the following description and the appended claims.

### BRIEF DESCRIPTION OF DRAWINGS

FIG. 1 shows the steps of a method for determining the CMC, according to embodiments herein, by measuring the sedimentation velocity of a surfactant under centrifugation.

FIGS. 2A-2B are plots of sedimentation velocity versus surfactant concentration for a cationic surfactant (CTAB) and a nonionic surfactant (Tween®-80).

FIG. 3 shows a plot of sedimentation velocity versus surfactant concentration for an anionic surfactant (SDS).

### DETAILED DESCRIPTION

Current analytical methods to determine the CMC of surfactants are time consuming and require large sample volume. For example, one method to determine the CMC of surfactants measures the surface tension and requires at least 5 hours to complete and at least 500 mL of sample volume.

The present disclosure relates to a method for measuring the critical micelle concentration of surfactant solutions using centrifugation and light transmission intensity techniques to determine the sedimentation velocity of surfactant molecules at different surfactant concentrations, from which the CMC is inferred. The disclosed method is fast, taking about 15 minutes in some embodiments, and is efficient, accurate, and requires small sample volumes. Specific embodiments of the disclosure will now be described in detail.

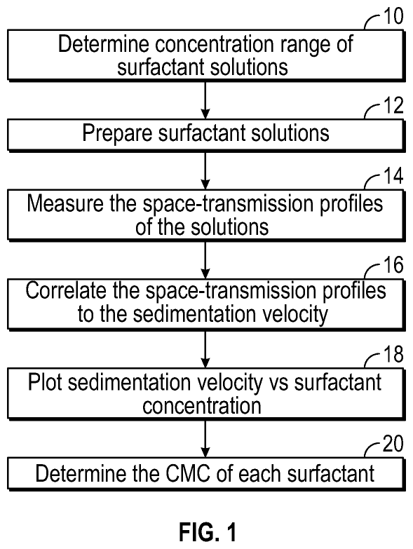

The steps in determining CMC for a surfactant according to one or more embodiments may involve preparing homogeneous surfactant solutions with different surfactant concentrations, measuring transmittance profiles of the surfactant solutions in a dispersion analyser under centrifugal force, translating the changes in the transmission profiles of the surfactant solutions to the sedimentation velocity, and using the relationship between the sedimentation velocity and the surfactant concentration to determine the critical micelle concentration of the surfactant. FIG. 1 shows the overall steps to measure the CMC of surfactant solutions according to some embodiments herein, each step being described further below.

Turning to FIG. 1, in some embodiments, a first step in determining CMC for a surfactant is determining a concentration range of surfactant solutions (Step 10). A second step is then to prepare suitable surfactant solutions having a defined concentration (Step 12). A third step is measuring a space-transmission profile of the surfactant solutions (Step 14). A fourth step is correlating the space-transmission profiles to a sedimentation velocity (Step 16). A fifth step is plotting the sedimentation velocity versus the surfactant solution concentrations (Step 18). A final step is to determine the CMC of each surfactant (Step 20). Each of the steps in this exemplary embodiment is discussed in detail below.

### Step 10: Experiment Planning and Concentration Test Range

A first step of the method may include planning of the experiment. Experimental planning may involve determining an appropriate range of concentrations over which to test the surfactant solutions. Several factors may affect the CMC of a surfactant, including but not limited to the size and structure of hydrophobic group, nature of the hydrophilic group, and nature of counter ions. Variables that may affect the CMC of a surfactant include not only the chemical nature of surfactant, but also the fluid in which the CMC is being measured. Salinity, pH, and temperature may impact CMC, as may other components often used in drilling fluids or enhanced oil recovery (EOR) fluids. For example, the addition of alcohol to an aqueous solution may reduce the dielectric constant and may increase the capacity of a solution to solubilize amphiphilic surfactants and hydrophobic molecules. Thus, greater amphiphilic surfactant solubility in the hydroalcoholic solutions decreases the surface/interface to bulk solution concentration of the surfactant, therefore increasing the CMC. As such, according to the end use and its primary fluid components, and the type of surfactant, an appropriate surfactant concentration range for the studies may be selected.

Test concentration ranges may be selected to overlap a known CMC of the same or chemically similar surfactants (type of surfactant, type of end group, or other variables that may provide some insight) dispersed in a comparable fluid. For example, the known CMC may be the CMC of a surfactant in deionized water, whereas the test may be determining CMC with respect to use of the surfactant in a saline solution. As optimization of the surfactant concentration may save costs or improve performance of the desired end use, the known CMC may be used to provide insight as to a suitable test range.

In other embodiments, the test concentration ranges may be selected so as to be over an initially broad range of concentration, the test results for which may inform a narrower range to investigate in a second set of experiments so as to accurately determine the CMC.

When planning the experiments of one or more embodiments, the homogeneous surfactant solution may be prepared in at least five different concentrations. The number of solutions prepared at different concentrations may be six, or may be seven, or may be eight, or may be nine, or may be ten, or may be eleven, or may be twelve. As will be understood by a person of ordinary skill in the art, the initial range of concentrations tested will be in an appropriate range and may be adjusted as needed to a higher or lower concentration range. The test concentration range may be selected to encompass a concentration value at which an extremum value of the sedimentation velocity is anticipated. In one or more embodiments, such as where a broad concentration range is initially tested, this adjustment in the concentration may be based on the sedimentation velocity measured for an initial set of test solutions.

### Step 12: Surfactant Solution Preparation

A second step in determining the CMC, after the determination of the appropriate concentration range, according to embodiments herein may include surfactant solution preparation. The surfactant solutions may be prepared in a variety of fluids. The choice of fluid may be contingent on the end use of the surfactant. For example, if the surfactant is used in oil recovery, the CMC in water, solvent, or brine may be necessary. Therefore, the surfactant solutions may be prepared in any appropriate fluid that fully dissolves the surfactant and results in a homogenous surfactant solution. The homogeneous surfactant solution of one or more embodiments may be prepared by dissolving the surfactant in aqueous or non-aqueous fluids. The aqueous fluids may include deionized water, seawater, brines, calcium chloride solutions, and the like.

The CMC may be determined for anionic, amphoteric, cationic, or nonionic surfactants, depending on the end use of the surfactant. For example, cationic surfactants used in oil recovery may include dodecyltrimethylammonium chloride (DTAC), tetradecyltrimethylammonium chloride (TTAC), or cetyltrimethylammonium bromide (CTAB). Anionic surfactants used in oil recovery may include sodium dodecyl sulfates (SDS), alcohol propoxy sulfate (APS), or alkyl aryl disulfonate (ADS). Examples of nonionic surfactants used in oil recovery may include sodium dodecyl sulfates (SDS), alcohol propoxy sulfate (APS), or alkyl aryl disulfonate (ADS).

In one or more embodiments, the surfactant may be anionic. Anionic surfactants may include surfactants such as ammonium lauryl sulfate, sodium laureth sulfate, sodium lauryl sarcosinate, sodium myreth sulfate, sodium pareth sulfate, sodium stearate, sodium lauryl sulfate, a olefin sulfonate, and ammonium laureth sulfate, among many others. Anionic surfactant concentration ranges may be from 2.0 mM to 30 mM. For example, for surfactant SDS, a test ranges from about 2.5 mM to about 28 mM may be used. Other anionic surfactants may be tested over a similar range, or a different rage as may be appropriate for the particular anionic surfactant.

In one or more embodiments, the surfactant may be cationic, such as triethylamine hydrochloride, octenidine dihydrochloride, cetrimonium bromide, cethexonium bromide, cetylpyridiniun chloride, benzethonium chloride, or dimethyldioctadecylammonium chloride. Cationic surfactant concentration ranges may be from 0.05 mM to 3.00 mM. For example, for CTAB, a test ranges from about 0.05 mM to about 2.30 mM may be used. Other cationic surfactants may be tested over a similar range, or a different range as may be appropriate for the particular cationic surfactant.

In one or more embodiments, the surfactant may be nonionic, such as ethoxylates, alkoxylates, and cocamides. Nonionic surfactant concentration ranges may be from 0.3 μM to 300 μM. For example, for Tween®-80, a test range from about 0.3 μM to about 260 μM may be used. Other nonionic surfactants may be tested over a similar range, or a different rage as may be appropriate for the particular nonionic surfactant.

In one or more embodiments, the surfactant may be amphoteric, such as, cocamidopropyl betaine, oleyl polyoxyethylene amidopropyl carboxybetaine, or oleyl polyoxyethylene amidopropyl carboxybetaine.

### Step 14: Transmittance Profile Measurement

A third step in determining the CMC according to embodiments herein may include measuring the transmittance profile of the surfactant solutions prepared. The transmittance profile of the solutions prepared in step 12 may be measured by transferring the solutions from the vials into sample cells. Light transmission may be measured during centrifugation of the surfactant solutions placed in the sample cells by measuring the signal intensity. The light transmission may be collected as a function of radial position. As such, the x-axis may represent the radial position of the measurement and the y-axis may represent the normalized transmission intensity. The transmission profile may be space- and/or time-resolved. Parameters such as centrifugation time, temperature, rotor speed, and number of transmission profiles collected may be determined based on the end use of the surfactant. For example, if the surfactant is to be used in oil recovery, the transmittance profile may be measured at a temperature higher than room temperature.

The transmittance profile in one or more embodiments may be measured using a dispersion analyzer under centrifugal force. In one or more embodiments, the prepared surfactant solutions of different concentrations may be each placed in a different sample cell. The analyzer may analyze solutions that are aqueous, non-aqueous, Newtonian or non-Newtonian. The analyzer may analyze at least 5, 6, 7, 8 and up to 9, 10, 11, or 12 surfactant solutions of different known concentrations instantaneously.

In one or more embodiments, the dispersion analyzer measures the transmitted light across the enter length of the surfactant solutions when placed in a sample cell under centrifugal force. The light may be generated from multiple light sources including but not limited to near infrared or blue light. In some embodiments, the transmitted light may be measured by more than 2000 detectors associated with the measurement system. In one or more embodiments, 1 profile may be collected every 5 seconds. The transmission profile in one or more embodiments may be space-transmission profile and at least 100 space-transmission to about 200 profiles may be collected in about 15 minutes. The transmission profiles collected in about 15 minutes in one or more embodiments may be at least 100, 105, 110, 115, 120, 125, 130, 135, 140, 145, 150 and up to 155, 160, 165, 170, 175, 180, 185, 190, 195 or 200.

Changes in the transmission profile under centrifugation of the surfactant solution in one or more embodiments may be correlated to several solution properties, such as dispersion size, stability index, sedimentation velocity, creaming velocity, and sedimentation and creaming height.

The centrifugation time of a surfactant solution analyzed should be appropriate to the particular solution/surfactant being measured, and the time should be sufficient for the transmission profiles to provide an accurate and reliable determination of the corresponding sedimentation velocity. In one or more embodiments, the surfactant solutions may be placed under centrifugal force and transmittance spectra collected may be at least 15 minutes under appropriate centrifugation speed. The centrifugation time in one or more embodiments may be at least 15 min, 16 min, 17 min, 18 min, 19 min, or 20 min. For more viscous solutions, longer centrifugation times may also be appropriate. For highly soluble surfactants, longer times may be needed and vice versa.

The volume of surfactant solution analyzed should be appropriate to the equipment and be suitable to obtain reliable data. In one or more embodiments, the volume of the surfactant solution placed inside the sample cell may be in a range of from about 0.5 mL and to about 2.0 mL. The volume of the surfactant solution analyzed in one or more embodiments may be at least 0.5 mL, 0.6 mL, 0.7 mL, 0.8 mL, 0.9 mL, 1.0 mL, 1.1 mL, and up to 1.2 mL, 1.3 mL, 1.4 mL, 1.5 mL, 1.6 mL, 1.7 mL, 1.8 mL, 1.9 mL, or 2.0 mL.

Methods according to embodiments herein may be conducted at room temperature or to mimic down hole temperatures up to 200° C. The temperature range over which the transmittance profiles may be are measured may be limited based on the particular analyzer capabilities, however. In some embodiments, the temperature under which the surfactant solutions may be placed under centrifugal force and transmittance spectra collected may be in a range of from about 4° C. to about 60° C. The temperature under which the surfactant solutions may be centrifuged and transmission profiles collected in one or more embodiments may be at least 5° C., 10° C., 20° C., 30° C., 40° C., 50° C., 60° C., 70° C., 80° C., 90° C. and up to 60° C., 75° C., 100° C., 110° C., 120° C., 130° C., 140° C., 150° C., 160° C., 170° C., 180° C., 190° C., or 200° C.

The appropriate centrifugation speed may depend on the surfactant size and density. In some embodiments, the centrifuge rotor rotational speed of dispersion analyzer may be in a range of from about 200 rpm to about 4000 rpm. The centrifugation rotor rotational speed in one or more embodiments may be at least 200 rpm, 300 rpm, 400 rpm, 500 rpm, 600 rpm, 700 rpm, 800 rpm, 900 rpm, 1000 rpm, 1100 rpm, 1200 rpm, 1300 rpm, 1400 rpm, 1500 rpm, 1600 rpm, 1700 rpm, 1800 rpm, 1900 rpm, 2000 rpm and up to 2100 rpm, 2200 rpm, 2300, rpm, 2400 rpm, 2500 rpm, 2600 rpm, 2700 rpm, 2800 rpm, 2900 rpm, 3000 rpm, 3100 rpm, 3200 rpm, 3300 rpm, 3400 rpm, 3500 rpm, 3600 rpm, 3700 rpm, 3800 rpm, 3900 rpm or 4000 rpm. The selection of the rotor speed may influence the sedimentation of surfactant molecules.

### Step 16: Transmission Profile to Sedimentation Velocity Correlation

A fourth step in determining the CMC according to embodiments herein may include correlating the transmittance profile of the surfactant solutions to the sedimentation velocity. This correlation may be done by a software in the analytical instrument. Sedimentation velocity may be understood by considering the forces acting on a molecule during a sedimentation.

In one or more embodiments the space-transmission profiles collected may be used to calculate the sedimentation velocity of the prepared surfactant solutions according to a combination of the relationships below. Sedimentation velocity measures the rate at which molecules move in response to a force. The sedimentation velocity is described by the following equations:

$$\frac{\partial c}{\partial t} = - \frac{1}{r} \frac{\partial }{\partial r} ( c {ω}^{2} {sr}^{2} - Dr \frac{\partial c}{\partial r} ) \qquad Equation ( 1 )$$

where c is the concentration, t is time, r is radial position (the distance from the center of rotation), ω is the angular velocity, D is the diffusion coefficient and s is the sedimentation coefficient and is given by Equation 2 below:

$$s = \frac{μ}{{ω}^{2} r} \qquad Equation ( 2 )$$

where μ is the sedimentation velocity.

The diffusion coefficient represents the capacity of the surfactant molecules to diffuse in response to a concentration gradient. The sedimentation coefficient represents the sedimentation velocity (μ) of the surfactant molecule in response to the centrifugal force (ω²r). The sedimentation coefficient represents the sedimentation velocity (μ) of the surfactant molecule in response to the centrifugal force (ω²r). The sedimentation velocity in one or more embodiments may be obtained from the space-transmission profiles collected using a software in the dispersion analyser. Equation (1) calculates the sedimentation, which is the change of the concentration with time and radial position (distance from the center of rotation).

In one or more embodiments, the sedimentation velocity may be calculated from the space-transmission profiles by a software in the dispersion analyser.

### Step 18: Analyse Relationship of Sedimentation Velocity and Surfactant Concentration

A fifth step in determining the CMC according to embodiments herein may include analyzing the relationship between sedimentation velocity and surfactant concentration. In some embodiments, the analyses may include generating a graphical representation of the sedimentation velocity as a function of surfactant concentration. The surfactant solution may correspond to the surfactant solutions prepared in step 12. The sedimentation velocity may correspond to the values obtained in step 16.

In one or more embodiments, the relationship between the sedimentation velocity and surfactant concentration may be visualized by a graphical representation where the sedimentation velocity is plotted on the y-axis and surfactant concentration plotted on the x-axis.

### Step 20: CMC Determination from Sedimentation Velocity

A sixth step in determining the CMC according to embodiments herein may include determining the CMC from the relationship of sedimentation velocity vs. surfactant concentration plot by visual inspection. In some embodiments, a linear or non-linear relationship of sedimentation velocity as a function of surfactant concentration may be used to estimate an extremum of the sedimentation velocity. The concentration of the surfactant when the sedimentation velocity is at an extremum may correspond to or approximate the surfactant's CMC.

Other embodiments may include determining the CMC from a sedimentation velocity versus surfactant concentration plot. The CMC may be determined, for example, by making and analyzing a graph with sedimentation velocity on the y-axis and surfactant concentration on the x-axis.

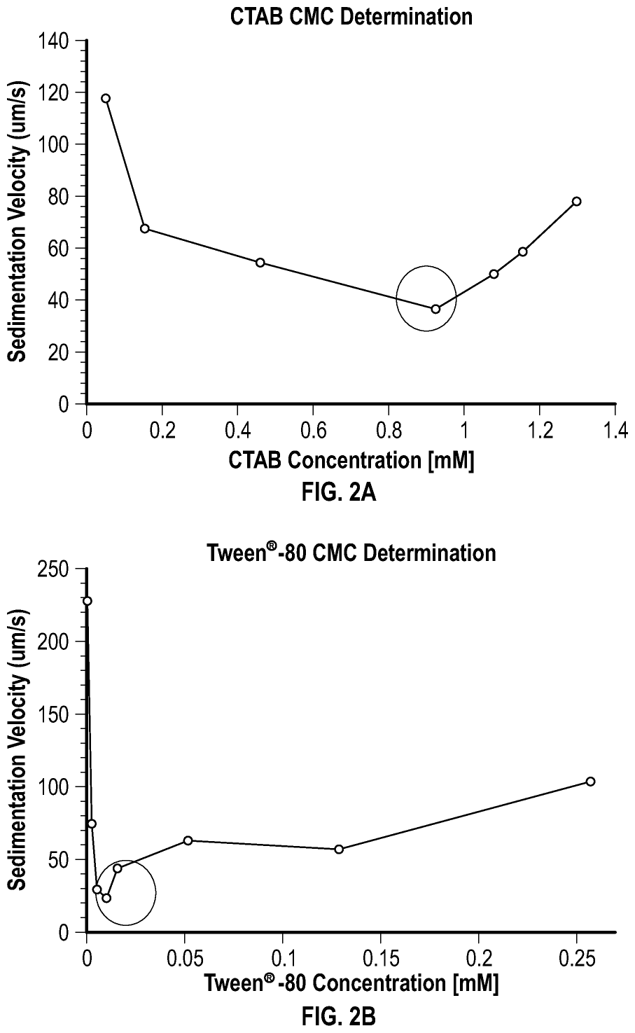

In one or more embodiments, the concentration of the surfactant when the sedimentation velocity is at an extremum may correspond to or approximate the surfactant's CMC. The sedimentation velocity versus surfactant concentration plot in one or more embodiments may follow a typical interfacial or surface tension versus surfactant concentration where the minimum value of the interfacial or surface tension may correspond to the CMC. As depicted in FIGS. 2A and 2B, cationic surfactant CTAB and nonionic surfactant Tween®-80 both follow a typical interfacial or surface tension versus surfactant concentration plot with the minimum value of the sedimentation velocity corresponds to the CMC. Notably, as shown in Table 2, the CMC of CTAB and Tween®-80 determined from the disclosed method is accurate and within the literature reported values.

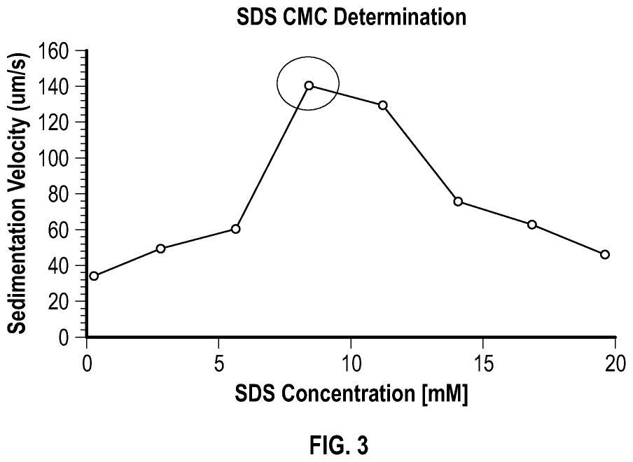

In yet another embodiment, the surfactant concentration at the maximum value of the sedimentation velocity may correspond to the CMC. As depicted in FIG. 3, the CMC of anionic surfactant SDS corresponds to surfactant value at the maximum value of the sedimentation velocity and does not follow a typical interfacial or surface tension versus surfactant concentration plot. Remarkably, as shown in Table 2, the CMC of SDS determined from the disclosed method is accurate and within literature reported values.

### EXAMPLES

The following examples are merely illustrative and should not be interpreted as limiting the scope of the present disclosure.

The CMC of three different types (cationic, anionic, and nonionic) of surfactants were determined.

### Materials

Cetyltrimethylammonium bromide (CTAB, cationic) and sodium dodecyl sulfate (SDS, anionic) were purchased from Sigma Aldrich. Tween®-80 (nonionic) was purchased from Fisher Scientific.

### Preparation of Surfactant Solution

8 different concentration of surfactant solutions were prepared for each of the cationic, anionic, and nonionic surfactants in deionized water. Specifically, CTAB, SDS, and Tween®-80 were used.

The concentration range was chosen such that it encompassed the surfactant concentration for which an extremum value of the sedimentation velocity was expected. The concentration range purposefully selected a known solvent (deionized water) and known surfactants so as to test the accuracy and reliability of methods herein.

The surfactant solutions were prepared by mixing a desired amount of surfactant in deionized water.

The concentration range of each of the surfactant solutions prepared is listed in Table 1.

TABLE 1
Concentration range of surfactants tested.

| Solution # | CTAB [mM] | SDS [mM] | Tween ®-80 [mM] |
|---|---|---|---|
| 1 | 2.300 | 27.922 | 0.25802 |
| 2 | 1.296 | 19.545 | 0.12901 |
| 3 | 1.152 | 16.753 | 0.05160 |
| 4 | 1.075 | 13.961 | 0.01548 |
| 5 | 0.922 | 11.169 | 0.01032 |
| 6 | 0.461 | 8.376 | 0.00516 |
| 7 | 0.154 | 5.584 | 0.00258 |
| 8 | 0.051 | 2.792 | 0.00032 |

### Determination of the CMC of Surfactants

Transmission profile measurements were conducted using a Multi-wavelength LUMiSizer® from LUM. An appropriate amount of each surfactant solution was placed in a 2 mm path length polyamide sample cell. The sample cells were then loaded into the dispersion analyzer. Twelve samples were analyzed simultaneously.

100-space transmission profiles were collected for each surfactant solution prepared by placing the surfactant into the sample cell and loading the sample cell into the dispersion analyzer. The dispersion analyzer was run at 4000 rpm for 10 minutes.

The software of the LUMiSizer® instrument was utilized to calculate the sedimentation velocity based on the 100-space transmission profiles collected.

The sedimentation velocity versus surfactant concentration was plotted for each of the surfactants. FIGS. 2A and 2B show the sedimentation velocity versus surfactant concentration plot of CTAB and Tween®-80 respectively. The CMC for both CTAB and Tween®-80 is at the surfactant concentration corresponding to the minima of the sedimentation velocity.

FIG. 3 shows the sedimentation velocity versus surfactant concentration plot for SDS. In contrast to CTAB and Tween®-80, the CMC of SMS is at the surfactant concentration corresponding to the maxima of the sedimentation velocity.

Table 2 illustrates the CMC measured by the sedimentation velocity method is within the range of reported results for these surfactants. The CMC of CTAB, SDS, and Tween®-80 were inferred to be 0.92 mM. 8.4 mM, and 0.0103 mM respectively which are within the range of the literature values reported.

TABLE 2
Comparison of CMC determined by sedimentation
velocity method and reported in the literature.

| | CMC by Sedimentation | CMC from the |
|---|---|---|
| Surfactant | Velocity (mM) | literature (mM) |
| CTAB | 0.92 | 0.9, 0.98 |
| SDS | 8.4 | 8.6, 8.0 |
| Tween-80 | 0.0103 | 0.012 |

Advantageously, by using centrifugation and light transmission techniques, according to embodiments of the present disclosure, the CMC for different types of surfactants can be determined accurately and efficiently from their sedimentation velocity. In contrast, conventional methods are time consuming, require additional reagents and large sample volume. The test method disclosed herein can limit cost of analysis by reducing the analysis time and sample volume needed for analysis. Additionally, the test method can be applied to any industry that utilizes surfactants, including oil and gas, food processing, surface cleaning, medical and pharmaceutical applications, cosmetics, and household applications.

Although the preceding description has been described with reference to particular surfactants and embodiments, it is not intended to be limited to the particulars disclosed; rather, it extends to surfactants, such as those within the scope of the appended claims.

The presently disclosed systems, apparatuses, methods, processes and compositions may suitably comprise, consist or consist essentially of the elements disclosed and may be practiced in the absence of an element not disclosed. For example, those skilled in the art can recognize that certain steps can be combined into a single step.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” or “proximate” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method for measuring critical micelle concentration of a surfactant, the method comprising:
preparing two or more surfactant solutions, each having a different concentration of the surfactant;
measuring transmittance profiles of the two or more surfactant solutions in a dispersion analyser under centrifugal force;
translating changes in the transmittance profiles of each of the two or more surfactant solutions to a sedimentation velocity; and
using a relationship between the sedimentation velocity and a surfactant concentration to determine the critical micelle concentration of the surfactant.

2. The method of claim 1, wherein the surfactant is anionic, cationic, or nonionic.

3. The method of claim 1, wherein a surfactant solution comprises water or deionized water.

4. The method of claim 1, wherein a number of the surfactant solutions prepared is in a range from 5 to 12.

5. The method of claim 1, wherein measuring the transmittance profiles of the surfactant solutions comprises:
transferring the surfactant solutions into a sample cell;
placing the sample cell containing the surfactant solution in the dispersion analyzer and applying the centrifugal force; and
measuring the transmittance profiles at multiple positions in the sample cell.

6. The method of claim 5, wherein the transmittance profiles are space-transmission profiles.

7. The method of claim 6, wherein a number of the space-transmittance profiles collected is at least 100.

8. The method of claim 1, wherein the transmittance profile is translated to a sedimentation velocity according to a combination of following relationships:
$$\frac{\partial c}{\partial t} = - \frac{1}{r} \frac{\partial }{\partial r} ( c {ω}^{2} {sr}^{2} - Dr \frac{\partial c}{\partial r} ) \qquad Equation 1$$
$$and$$
$$s = \frac{μ}{{ω}^{2} r} \qquad Equation 2$$
wherein c is the surfactant concentration, t is time, r is distance from center of rotation, ω is angular velocity, D is diffusion coefficient and μ is the sedimentation velocity.

9. The method of claim 1, wherein using the relationship between the sedimentation velocity and the surfactant concentration to determine the critical micelle concentration of the surfactant comprises:
making a plot of the sedimentation velocity vs. the surfactant concentration;
using the plot to infer the critical micelle concentration of the surfactant, wherein the critical micelle concentration is the surfactant concentration at or proximate an extremum of the plot.

10. The method of claim 9, wherein the extremum is a minimum or a maximum.

11. The method of claim 1, further comprising translating the transmittance profile or changes in the transmittance profile into a dispersion size, a stability index, a sedimentation velocity, a creaming velocity, or a sedimentation and creaming height.

12. The method of claim 1, further comprising:
determining a surfactant concentration corresponding to a maximum or a minimum of the sedimentation velocity for the two or more surfactant solutions;
preparing additional surfactant solutions having a concentration above and/or below the surfactant concentration corresponding to a maximum or a minimum of the sedimentation velocity;
measuring transmittance profiles of the additional surfactant solutions in a dispersion analyzer under centrifugal force;
translating changes in the transmittance profiles of each of the additional surfactant solutions to a sedimentation velocity; and
using a relationship between the sedimentation velocity and the surfactant concentration of the two or more surfactant solutions and the additional surfactant solutions to determine the critical micelle concentration of the surfactant.
